(19) United States
(12) Patent Application Publication
(10) Pub. No.: US 2012/0054110 A1
(43) Pub. Date: Mar. 1, 2012

(54) METHOD AND SYSTEM FOR INTEGRATING DOCUMENT WORKFLOW AND RENDERING LOGIC

(75) Inventor: Mark Vela, Palos Verdes Peninsula, CA (US)

(73) Assignee: Xerox Corporation

(21) Appl. No.: 12/869,204

(22) Filed: Aug. 26, 2010

(51) Int. Cl. G06Q 10/00

(52) U.S. Cl. 705/301

(57) ABSTRACT

A method and system for integrating a document workflow and a rendering logic in order to visually modify a document based on WYSIWYG application. A document incorporating a number of changes can be visually displayed by integrating a logic that interprets a workflow associated with the document with a rendering logic. The modified document can be realized by a rendering code associated with the rendering logic. The rendering logic can be then integrated with workflow logic in order to translate the modifications associated with the document to a workflow process step represented in an extensible markup language format. A final print ready document can be then created by executing the content and the workflow through a workflow engine. The final print ready document can also be transmitted to a production output device for final production.

### TECHNICAL FIELD

Embodiments are generally related to workflow management systems and methods. Embodiments also relate in general to the field of computers and similar technologies, and in particular to software utilized in this field. In addition, embodiments relate to the visual representation of a modified document.

### BACKGROUND OF THE INVENTION

In general, a workflow can be defined as a business process for transmitting a document, information, works, etc. from one user to another user according to a series of procedures and rules. A workflow system is an automatic system for collectively managing the workflow. The workflow system interprets and embodies a process composed of relations and flows between resources relating to, for example, the daily work of an organization, so that the user can follow this process.

A document workflow can be represented as a combination of content and process steps that modify the content to create a final print ready document. The process steps to create the document can be represented in Extensible Markup Language (XML) and interpreted by a workflow engine. Conventionally, the document can be modified by changing the process steps represented in XML to create a new final document. The document and the workflow must be executed through the workflow engine in order to view and verify if the modifications are in a right position. If the page modifications are not exactly correct, the process must be repeated until done correctly. Such prior art approaches for modifying the documents are both time consuming and inaccurate.

Based on the foregoing, it is believed that a need exists for an improved method and system for integrating a document workflow and a rendering logic to visually modify a document, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved workflow management method and system.

It is another aspect of the disclosed embodiments to provide for an improved method and system for integrating a document workflow and a rendering logic in order to visually modify a document.

The aforementioned aspects and other objectives and advantages can now be achieved as described herein. A method and system for integrating a document workflow and a rendering logic in order to visually modify a document based on WYSIWYG application, is disclosed herein. A document incorporating a number of changes can be visually displayed by integrating a logic that interprets a workflow associated with the document with a rendering logic. The modified document can be realized by a rendering code associated with the rendering logic. The rendering logic can then be integrated with workflow logic in order to translate the modifications associated with the document to a workflow process step represented in an Extensible Markup Language format. A final print ready document can be the created by executing the content and the workflow through a workflow engine.

A workflow management module can be configured to provide support for editing and annotating the document by a user and a result of the respective operations can be visually represented in a user interface. The final print ready document can also be transmitted to a production output device for final production. Such an approach modifies the workflow visually to assure accuracy of the final document and reduces time taken to modify the workflow to create the final document.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including operating system, application software, and a user interface for carrying out an embodiment;

FIG. 3 illustrates a block diagram of a workflow management system, in accordance with the disclosed embodiments;

FIG. 4 illustrates a visual representation of a modified document, in accordance with the disclosed embodiments; and

FIG. 5 illustrates a high level flow chart of operation illustrating logical operation steps of a method for integrating a document workflow and a rendering logic to visually modify a document, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

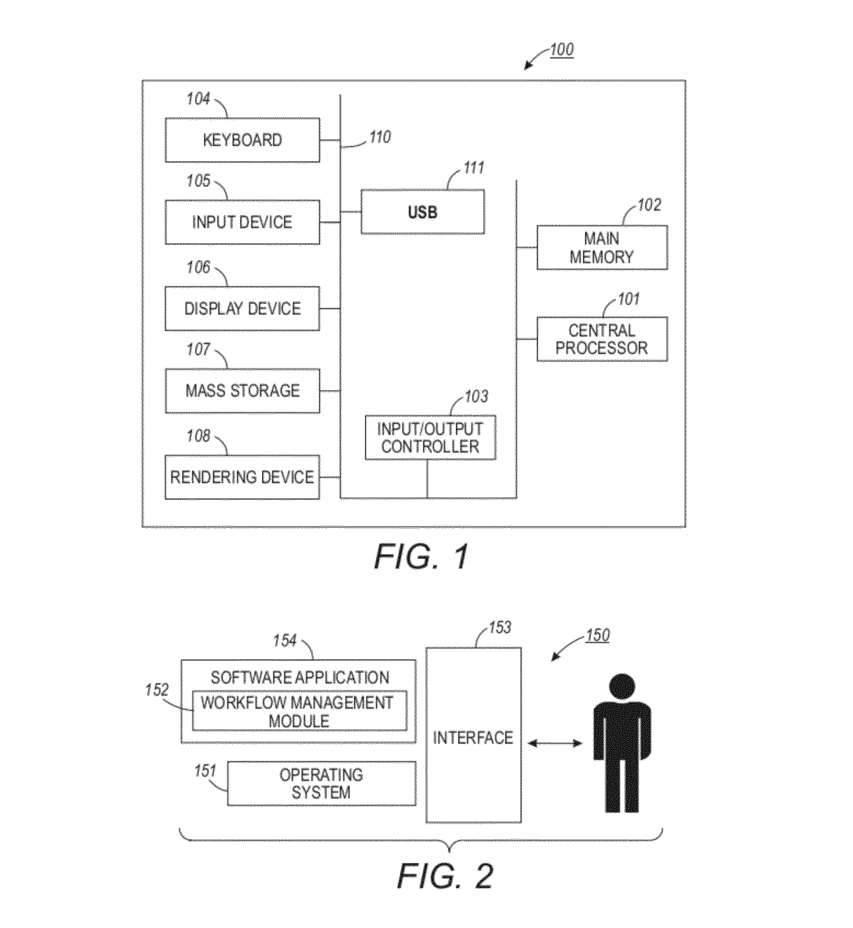

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, pen device, etc), a display device 106, a mass storage 107 (e.g., a hard disk), and a USB (Universal Serial Bus) peripheral connection 111. Additional input/output devices, such as a rendering device 108 (e.g., printer, scanner, fax machine, etc), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the method and system may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

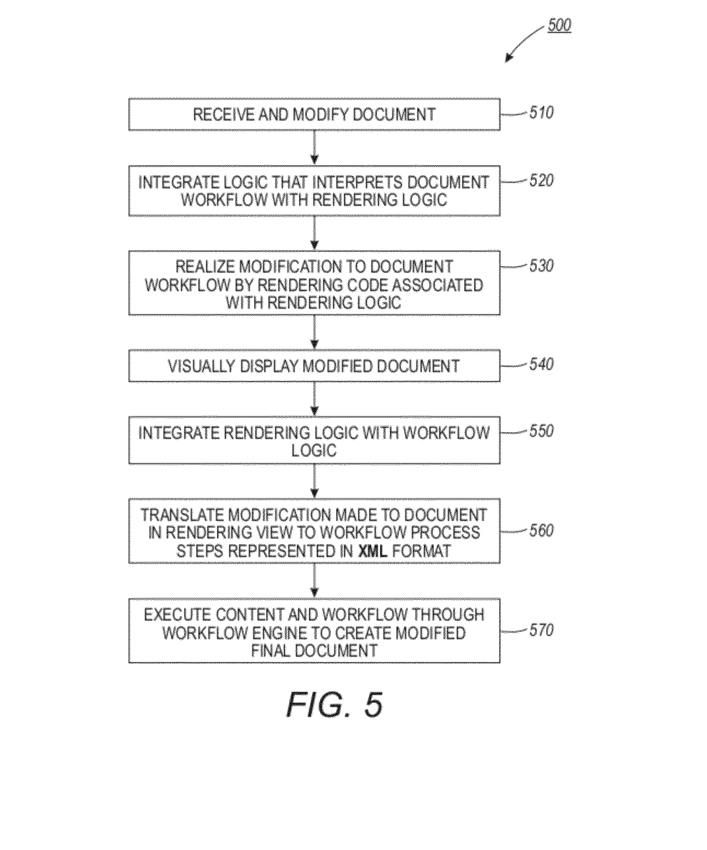

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 154 can include, for example, workflow management module 152 for visually modifying a document to create a final print ready document. The workflow management module 152 can include instructions, such as those of method 500 discussed herein with respect to FIG. 5.

FIGS. 1-2 are thus intended as an example, and not as an architectural limitation with respect to particular embodiments. Such embodiments, however, are not limited to any particular application or any particular computing or data-processing environment. Instead, those skilled in the art will appreciate that the disclosed method and system may be advantageously applied to a variety of system and application software. Moreover, the present invention may be embodied on a variety of different computing platforms, including Macintosh, UNIX, LINUX, and the like.

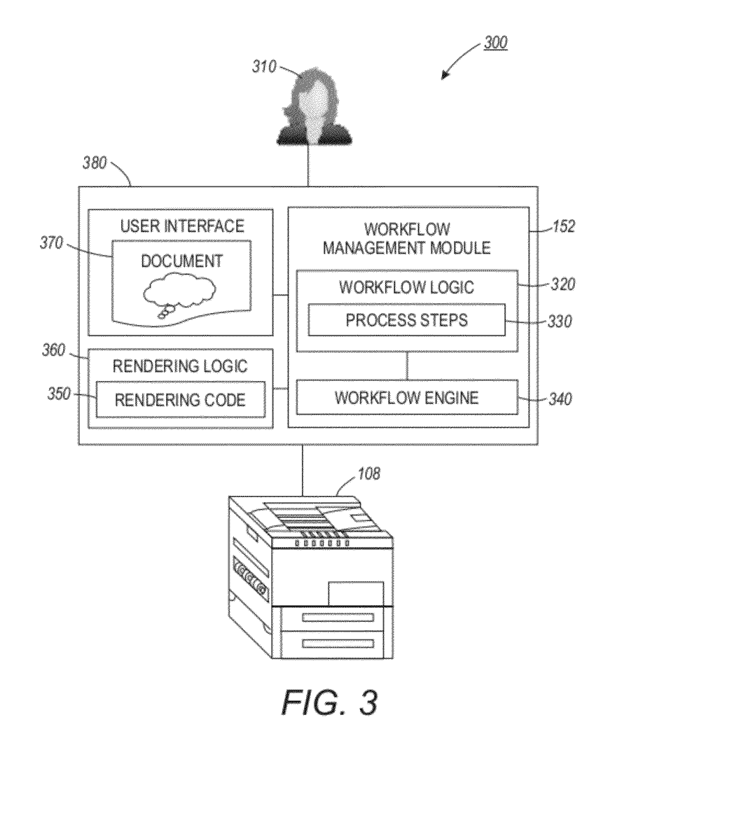

FIG. 3 illustrates a block diagram of a workflow management system 300, in accordance with the disclosed embodiments. Note that in FIGS. 1-5 identical parts or elements are generally indicated by identical reference numerals. The workflow management system 300 manages and defines a series of tasks within an organization to produce a final outcome. The workflow management system 300 defines different workflows for different types of jobs or processes. The workflow management system can be for example, a data-processing system 100, as depicted in FIG. 1. The workflow system 300 can be configured to include the workflow management module 152 for integrating a document workflow logic 320 and a rendering logic 360 in order to visually modify a document 370 based on WYSIWYG application.

WYSIWYG, is an acronym for “What You See Is What You Get”, an approach that is utilized in computing and data processing to describe content displayed during editing that appears very similar to a final output, which may be, for example, a rendered document, a web page, a slide presentation or even a lighting for a theatrical event, etc. WYSIWYG implies a user interface that permits a user to view something very similar to the end result while the document is being created. A typical WYSIWYG application can provide a high-quality rendered output and/or a high-quality onscreen output and allow the user to visualize what the document may look like when rendered.

The document 370 can be loaded into the workflow management module 152 and tools can be provided to perform value added services and prepare the document 370 for production. The workflow management module 152 further provides support for editing and annotating the document 370 by a user 310. The document 370 incorporating a number of changes can be visually displayed by integrating a logic 320 that interprets the workflow associated with the document 370 with the rendering logic 360. The modified document 370 can be realized by a rendering code 350 associated with the rendering logic 360.

A process step 330 with respect to the workflow 320 to create a document can be represented in XML programming language and interpreted by a workflow engine 340. XML is developed by the W3C as a pared down version of Standard Generalized Mark-up Language (SGML) which is designed specially for World Wide Web (Web) documents. XML enables designers to create their own customized tags to provide functionality not available with HTML. For example XML supports links that point to multiple documents as opposed to HTML links, which can reference just one destination each. The rendering logic 360 can be then integrated with workflow logic 320 in order to translate the modifications associated with the document 370 to the workflow process steps 330 represented in an Extensible Markup Language format. A modified final document can be created when the content and the workflow is executed through a workflow engine 340.

The results of the respective operations can be shown in a visual representation of the document 370 in a user interface 380. In the preferred embodiments, edits or annotations can be created or manipulated by pointing to a visual representation of the document and/or pages within the document 370 and selecting, dragging, dropping or clicking the representation and/or selecting from a menu of options, where the selection of a particular option causes the associated edit or annotation to be applied to the specified portions of the document 370. Alternatively, a palate of options can be displayed from which the user 310 can choose an option to apply to selected portions of the document 370. Further, the interface 380 may provide for a dialog box or other visual control for inputting control values for the edit or annotation such as the starting number of a Bates range. Finally, the workflow management module 152 provides tools to transmit the prepared documents 370 and any associated tickets to a production output device 108 for final production. Note that the production output device 108 can be for example the rendering device, as depicted in FIG. 1.

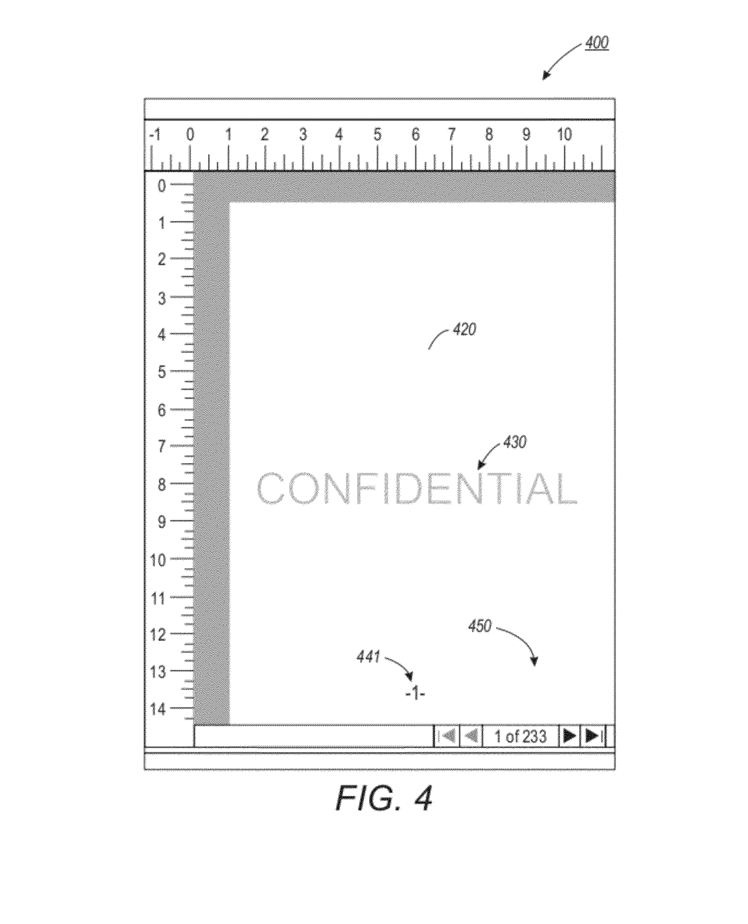

FIG. 4 illustrates a visual representation of a modified document 400, in accordance with the disclosed embodiments. The modified document 400 can be displayed on the graphical user interface 380. Note that the GUI 380 can be implemented utilizing a GUI such as, for example, the GUI 153 depicted in FIG. 2 herein, and may be provided by a module, such as, for example, module 152 (i.e., a software application). GUI 380 can be displayed via a display device such as display 106 depicted in FIG. 1. In the illustrated figures herein, the depicted GUI 380 can be implemented in the context of a GUI “window”. Note that in computing, a GUI window is generally a visual area containing some type of user interface (e.g., GUI 153). Such a “window” usually (but not always) possesses a rectangular shape, and displays the output of and may allow input to one or more processes. Such windows are primarily associated with graphical displays, where they can be manipulated with a mouse cursor, such as, for example, the pointing device 105 depicted in FIG. 1. A GUI using windows as one of its main “metaphors” is often referred to as a windowing system.

The document 400 is an 11×14 1/2 page comprising an image 420 of a tiger on the upper left hand corner. The workflow that is associated with the document 400 places a page number 440 and a watermark of annotated text 430 on the page. The modification can be visually represented as depicted in FIG. 4 if the document 400 is executed through the workflow engine 340. The user 310 can make modifications to the document 400 and the modifications can be represented in the final document accurately. For example, the operator can select the page number 440 or watermark object 430 and drag it to a new location. The operator can choose to add a new process step through menu selections, such as, for example, placing a bar code 450 in the bottom right corner of the document 400. The integrated code can modify the XML that represented the workflow to take account of the modifications made on the rendered simulation of the final document. The content can be transmitted along with the modified workflow to the workflow engine 340 if the operator is satisfied with the changes. A final print ready document which is similar to the document 400 can be then produced.

FIG. 5 illustrates a high level flow chart of operation illustrating logical operation steps of a method 500 for integrating the document workflow 320 and the rendering logic 360 to visually modify the document 370, in accordance with the disclosed embodiments. Note that the method 500 can be implemented in the context of a computer-useable medium that contains a program product, including, for example, a module or group of modules. The document 370 can be received and modified, as illustrated at block 510. The logic 320 that interprets the document workflow can be integrated with the rendering logic 360, as indicated at block 520. The modification to the document workflow 320 can be realized by the rendering code 350 associated with the rendering logic 360, as illustrated at block 530. The modified document 370 can be visually displayed, as indicated at block 540. The rendering logic 360 can be then integrated with the workflow logic 320, as depicted at block 550. Thereafter, as indicated at block 560, the modification made to the document 370 in the rendered view can be translated to the work flow process steps 330 represented in XML format. The content and the workflow can be executed through the workflow engine 340 in order to create a modified final document, as depicted at block 570. Such an approach modifies the workflow visually to assure final document accuracy and reduces the time taken to modify the workflow to create the final document.

Note that programs defining functions with respect to the disclosed embodiments may be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including, for example, Ethernet, the Internet, wireless networks, other networked systems. Thus, the method 500 described herein can be deployed as process software in the context of a computer system or data-processing system as that depicted in FIGS. 1-2.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A document workflow method, comprising:
visually displaying a document incorporating a plurality of changes by integrating a logic that interprets a workflow associated with said document with a rendering logic in order to thereafter realize said plurality of changes by a rendering code associated with said rendering logic;
integrating said rendering logic with a workflow logic in order to translate said plurality of changes associated with said document to a workflow process step represented in an extensible markup language format; and
creating a final document by executing said workflow process step with respect to said document through a workflow engine in order to thereafter transmit said final document to a production output device for final production.

2. The method of claim 1 further comprising modifying said document upon receiving said document.

3. The method of claim 1 further comprising configuring a workflow management module to provide support for editing and annotating said document by a user.

4. The method of claim 1 further comprising modifying said workflow via said rendering code associated with said rendering logic.

5. The method of claim 1 further comprising visually representing said document in a user interface.

6. The method of claim 5 further comprising configuring said user interface to display a visual control for inputting control values for editing said document.

7. The method of claim 3 further comprising configuring said workflow management module to provide at least one tool for transmitting said document and an associated ticket to said production output device for final production.

8. A document workflow system, comprising:
a processor;
a data bus coupled to said processor; and
a computer-usable medium embodying computer code, said computer-usable medium being coupled to said data bus, said computer program code comprising instructions executable by said processor and configured for:
visually displaying a document incorporating a plurality of changes by integrating a logic that interprets a workflow associated with said document with a rendering logic in order to thereafter realize said plurality of changes by a rendering code associated with said rendering logic;
integrating said rendering logic with a workflow logic in order to translate said plurality of changes associated with said document to a workflow process step represented in an extensible markup language format; and
creating a final document by executing said workflow process step with respect to said document through a workflow engine in order to thereafter transmit said final document to a production output device for final production.

9. The system of claim 8 wherein said instructions are further configured for modifying said document upon receiving said document.

10. The system of claim 8 wherein said instructions are further configured for providing a workflow management module that supports editing and annotating of said document by a user.

11. The system of claim 8 wherein said instructions are further configured for modifying said workflow via said rendering code associated with said rendering logic.

12. The system of claim 8 wherein said instructions are further configured for visually representing said document in a user interface.

13. The system of claim 12 wherein said instructions are further configured for arranging said user interface to display a visual control for inputting control values for editing said document.

14. The system of claim 10 wherein said instructions are further configured for arranging said workflow management module to provide at least one tool for transmitting said document and an associated ticket to said production output device for final production.

15. A document workflow system, comprising:
a processor;
a data bus coupled to said processor; and
a computer-usable medium embodying computer code, said computer-usable medium being coupled to said data bus, said computer program code comprising instructions executable by said processor and configured for:
visually displaying a document incorporating a plurality of changes by integrating a logic that interprets a workflow associated with said document with a rendering logic in order to thereafter realize said plurality of changes by a rendering code associated with said rendering logic;
integrating said rendering logic with a workflow logic in order to translate said plurality of changes associated with said document to a workflow process step represented in an extensible markup language format;
creating a final document by executing said workflow process step with respect to said document through a workflow engine in order to thereafter transmit said final document to a production output device for final production; and
modifying said document upon receiving said document.

16. The system of claim 15 wherein said instructions are further configured for providing a workflow management module that supports editing and annotating of said document by a user.

17. The system of claim 15 wherein said instructions are further configured for modifying said workflow via said rendering code associated with said rendering logic.

18. The system of claim 15 wherein said instructions are further configured for visually representing said document in a user interface.

19. The system of claim 18 wherein said instructions are further configured for arranging said user interface to display a visual control for inputting control values for editing said document.

20. The system of claim 15 wherein said instructions are further configured for arranging said workflow management module to provide at least one tool for transmitting said document and an associated ticket to said production output device for final production.
